(19) United States
(12) Patent Application Publication
(10) Pub. No.: US 2005/0172720 A1
(43) Pub. Date: Aug. 11, 2005

(54) Method and device for detecting changes or damages to pressure vessels while or after undergoing a hydraulic pressure test

(76) Inventor: Karlheinz G. Schmitt-Thomas, Munich (DE)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/972,597

(22) Filed: Oct. 25, 2004

(30) Foreign Application Priority Data
Nov. 13, 2003 (DE) 103 53 081.9

(51) Int. Cl. G01P 3/00

(52) U.S. Cl. 73/702

(57) ABSTRACT

A method for detecting changes or damages to pressure vessels while they are undergoing a hydraulic pressure test involves the following steps; Inducing a tone on the pressure vessel while pressurizing the pressure vessel during the hydraulic pressure test and evaluating the tonal spectrum induced on the pressure vessel.

The invention relates to a method with which any hazards emanating from pressure vessels because of damage done to a pressure vessel during a hydraulic pressure test can still be detected while performing the hydraulic pressure test. Changes in the vessel, i.e., damages, can also be detected while comparing the tonal spectrum of the vessel before the test to the spectrum after the test.

Safety regulations require that pressure vessels be subjected to one-time and recurring tests prior to commissioning and for the duration of their operation at specific intervals. One such test to be performed on pressure vessels or evaporators is the so-called hydrostatic test. In this case, the pressure vessel is exposed to an excess pressure during the test.

During the hydrostatic test or other tests involving an excess pressure, for example, it is known that the pressure vessel can form cracks or deformations that cannot be immediately recognized as damage, but only develop into noticeable disruptions or damages during later operation. For this reason, pressure vessels are preferably monitored during the hydrostatic test in such a way as to prevent undetected flaws from arising.

### PRIOR ART

The so-called sound emission recording (SE analysis) is known as such a monitoring method during a hydraulic pressure test. The principle underlying sound emission proceeds from the fact that the external forces acting on the material or component are converted into dimensional changes or crack formations. Such dimensional changes or crack formations are typically reflected in the sound emission, and generate signals to be allocated accordingly. These are continuous emissions in the case of deformations, and so-called burst signals in the case of crack formation. However, sound emission monitors are known to be hampered by numerous parasitic effects, thereby often giving rise to misinterpretations. For example, setting noises or frictional noises generate spurious signals, which prevent the acquisition of reliable information. Therefore, sound emission analysis can only be used conditionally to monitor the pressure vessel while subjecting it to a hydraulic pressure test.

Known from EP 0 636 881 B1 is a method for inspecting the quality of components, in particular ceramic components, via tonal measurement. The method is used in particular for inspecting the quality of ceramic components, e.g., roofing tiles. For inspection purposes, the component is subjected to mechanical impact, and induced to emit an acoustic tone. The generated tonal spectrum is recorded, and then analyzed and evaluated over a predetermined frequency range relative to the amplitudes assigned to the frequency contents by means of FFT (Fast Fourier Transformation). The evaluation can generally take place based on the position and height of the individual frequencies. In the evaluation performed in EP 0 636 881 B1, for example, the amplitudes of the amplitude frequency are added together, the sum of amplitudes is divided by the number of reversal points present between the peaks of the frequency contents in the amplitude frequency spectrum, and the obtained quotient is defined as the weighting number.

### DESCRIPTION OF INVENTION

The object of the invention is to provide a monitoring method during the hydraulic pressure testing in particular of vessels and pipes, along with a corresponding device for executing the method, which can be used to obtain reliable information about any impairment to the pressure vessel during the hydraulic pressure test.

This object is achieved with a method having the features in claim 1 and a device having the features in claim 15. The dependent claims characterize preferred embodiments.

The invention is based on the idea of providing tonal testing systems and tonal testing methods with which pressure vessels are monitored while being pressurized during a hydraulic pressure test. A tonal test is concurrently performed to isolate any impairment to the pressure vessel during the hydraulic pressure test. In this case, the tonal spectrum is evaluated while monitoring the hydraulic pressure test based on different criteria, during which the peak heights of the individual frequencies or the flank rise can be taken into account, for example. In this case, the evaluation can take place, for example, by comparing the tonal spectra recorded at different times during the hydraulic pressure test, comparing such a tonal spectrum with a spectrum known beforehand, comparing two spectra (before and after the test) or evaluating the tonal spectrum using other criteria, similar to the method described in EP 0 636 881 B1. In addition, two tonal spectra induced at different locations of the vessel can be evaluated relative to the echo time differences of the sound toward a common receiver, making it possible to gauge the integrity of the pressure vessel.

In particular, the principle of monitoring components during an increasing pressure is based on shifting the tonal spectrum to higher frequencies as the pressure on the vessel rises, similarly to an increasingly strained chord of an instrument. If the spectrum remains essentially unchanged relative to the position and height of the amplitudes, as well as to their rise and fall outside of the mentioned shift at two different times during the hydraulic pressure test, it can be concluded that the vessel was not damaged during the hydraulic pressure test. Use is also made of the fact that the component is generally filled with a liquid medium, e.g., water, during the test, which increases sound transmission. This results in an improved measuring accuracy. After the hydraulic pressure test, the tonal spectrum can be evaluated by means of an FFT analysis, and conclusions may be drawn about changes in the component from the established criteria, e.g., the height of the amplitudes, the shapes of the frequency peaks, the steepness of the flank rise and/or fall, or even the shift in the overall spectrum. In addition, the type of changes involved can be analyzed if needed (cracks, expansions, deformations, etc.). At the same time, the method is relatively easy to implement during the hydraulic pressure test, in particularly requiring no special precautions for the pressure vessel.

The method can be used for all types of pressure vessels. It is particularly suited for metal pressure vessels.

### BRIEF DESCRIPTION OF DRAWINGS

The invention will be described by example based on the attached figures, wherein:

FIG. 1 shows an example of a device for detecting changes or damages to pressure vessels during the hydraulic pressure test;

FIG. 2 shows an example of a shift in the frequency spectrum during the hydraulic pressure test, and

FIG. 3a and 3b show examples of the tonal spectrum for a crack-free pressure vessel (FIG. 3a) and a cracked pressure vessel (FIG. 3b) after the tonal test.

### WAYS OF IMPLEMENTING THE INVENTION

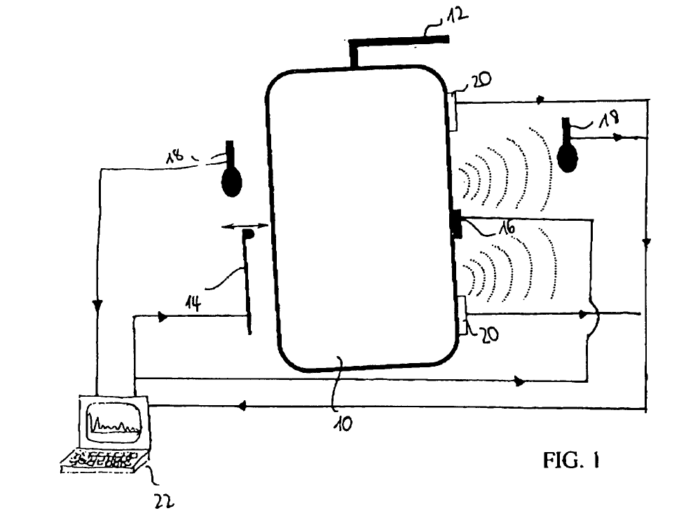

FIG. 1 shows a pressure vessel 10 to be subjected to a hydraulic pressure test. During the hydraulic pressure test, the pressure vessel can be exposed to pressure by introducing a pressurized fluid, e.g., a liquid, through line 12. Pressurization can be of a kind that yields a continuous or incremental rise or fall in pressure or a continuous pressure lying in between, or that generates a uniform or non-uniform sequence of pressure rises and falls, if necessary not always returning to ambient pressure. In particular, the hydraulic pressure test is most often performed in such a way as to have a phase in which the pressure rises up to a maximum pressure, followed immediately by a phase in which the pressure falls, e.g., back down to the initial pressure.

In order to subject the pressure vessel 10 to a tonal test during the hydraulic pressure test for detecting changes or damages to the pressure vessel, the pressure vessel is provided with sound generators, e.g., a clapper 14, with which a tone is sounded, for example, by means of a simple impact or multiple impact (e.g., double impact), i.e., via two or more short, successive impacts, against the specimen. The sound generated is correlated to the rising test pressure.

The testing arrangement provides buzzers 16 as another type of sound generator in the embodiment shown. As an alternative, for example, vibrating devices or tripping devices for a magnetostriction effect are also possible. The magnetostriction effect can here be induced in the specimen itself if made of ferromagnetic material, or generated by magnetostrictively excited oscillators, e.g., nickel oscillators, and the oscillation can be introduced into the specimen. IF needed, several identical or different sound generators can be combined in a pressure vessel, as in the example shown, and secured to the pressure vessel at different locations. However, it is also possible to provide only a single sound generator. Tonal excitation on the pressure vessel 10 can take place on any of the sound generators in a uniform or non-uniform time cycle, and can be done manually or program-controlled. In particular, it is preferred that tonal excitation take place given a rising or falling internal pressure of the specimen with an increasing or decreasing clock frequency. In addition, the sound generator can be triggered manually or program-controlled on the pressure vessel 10 to be tested, as needed.

The arrangement for detecting changes or damages to pressure vessels 10 during the hydraulic pressure test also contains sound transducers, which are suitable for acquiring the induced sound over a broad spectrum, and relay it as an output signal to an evaluator (e.g., an FFT analyzer). In the embodiment shown, the arrangement has two air microphones 18 positioned at different locations, which record airborne sound, and two structure-borne sound microphones 20, which are secured directly to the pressure vessel 10 at different locations, and acquire the structure-borne sound of the pressure vessel 10. As in the sound generators, it is possible in the sound transducers to optionally provide exclusively structure-borne sound transducers or airborne sound transducers or combinations of structure-borne and airborne sound transducers. It is also preferred to provide multiple sound transducers, either several sound transducers of the same kind or several sound transducers of a different kind, and to position the several sound transducers at various locations on or around the pressure vessel 10. In this case, the difference in spectra is obtained as an additional criterion, and can be recorded simultaneously at different locations.

The evaluator 22 to which the output signal of the sound transducer is relayed contains a storage medium for storing the excited tonal spectrum, and processing means to evaluate the tonal spectrum based on prescribed criteria. It also contains means for displaying the analysis results. The evaluator 22 can simultaneously be used as a controller for the sound generators, in particular also provide any type of program-controlled excitation desired.

When monitoring the pressure vessel 10 as it is undergoing a hydraulic pressure test, the sound generator induces a tone, preferably at several locations of the pressure vessel, in such a way that tonal excitation preferably takes place both as the pressure rises and as it falls in the pressure container 10. It is especially preferred that excitation take place at two different times during the hydraulic pressure test, if necessary at different pressures, and that evaluation be performed by comparing the tonal spectra induced from the different times. The excited tone is subsequently recorded as structure-borne and/or airborne sound by the sound transducers. If several locations are provided for recording the sound, the sound can be recorded simultaneously or sequentially at several locations and, if needed, logged.

The tonal spectrum of the induced tone is subsequently analyzed in the evaluator 22, wherein the various sound echo times or echo time differences must be considered and assessed given several recording locations, for example. Sound transmission influences can here be taken into account. In this case, several ways of localizing potentially encountered errors arise during the echo time.

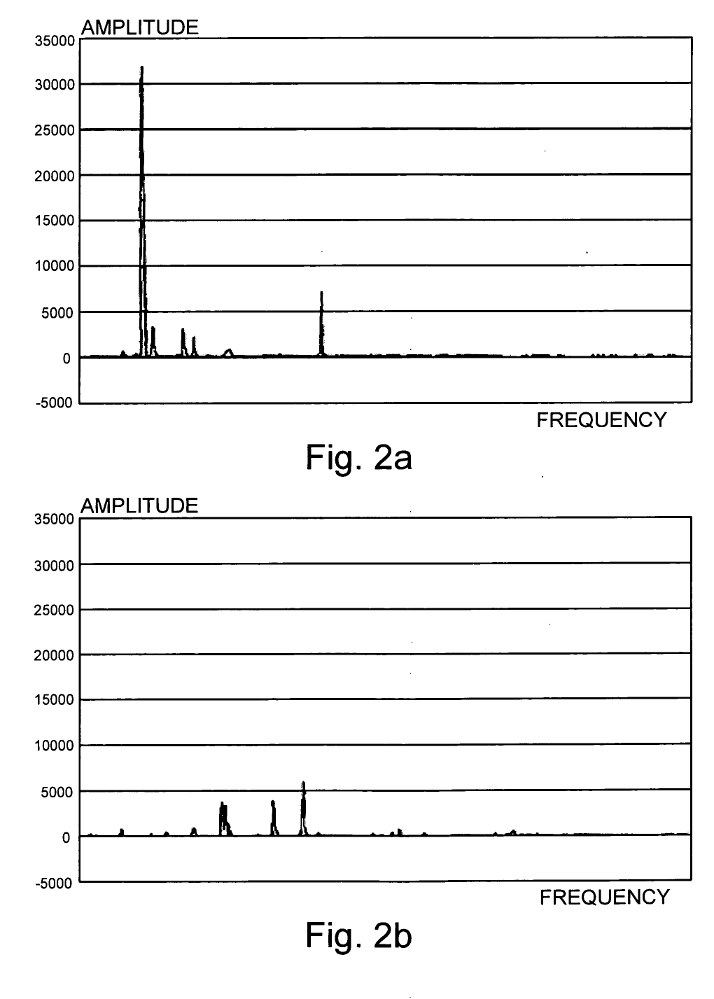

Additionally or alternatively, two tonal spectra excited at different times during the hydraulic pressure test at different pressures can be compared based on the shift in tonal spectrum at an increasing pressure. The solid line on FIG. 2 shows the frequency spectrum after tonal excitation during the hydraulic pressure test at a relatively low initial pressure in the pressure vessel 10. The frequency spectrum represented by the dashed line shows the frequency spectrum of the same vessel, and at a higher pressure inside the pressure vessel given the same type of excitation. As evident, the frequency spectrum essentially shifts to higher frequencies with relatively small changes in shape as pressure rises, similarly to the effect of an increasingly strained chord of an instrument. In the spectra shown, it can therefore be concluded that the vessel remained intact during the hydraulic pressure test.

In addition, the position of individual frequencies, the height of the amplitudes, the shape of the frequency peaks and/or the steepness of the flank rise or fall can be taken into account and evaluated, wherein the tonal spectrum is recorded both during the rising pressure and falling pressure.

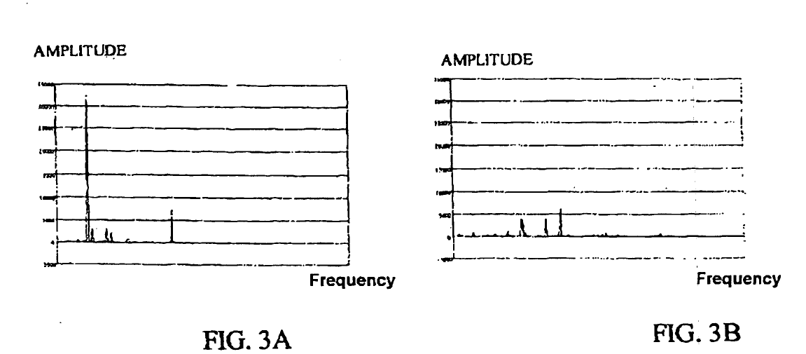

FIG. 3a shows a frequency spectrum of tonal emission on a pressure vessel 10 that concluded the hydraulic pressure test without any impairment, i.e., free of cracks, while FIG. 3b shows the frequency spectrum of the corresponding pressure vessel, but one that experienced damages during the hydraulic pressure test. Similarly to product testing, this can be concluded from the fact that components without cracking and slackening yield a comparatively pure spectrum with individual, distinct frequencies. If there is cracking and slackening, a spectrum with numerous, but lower frequencies is obtained (so-called “jangle”). By contrast, FIG. 3b shows a spectrum that arises after a test if a defect, in particular a crack, was generated, as opposed to the “pure” spectrum (FIG. 3a). Comparing the spectra before and after a hydraulic pressure test makes it possible in this way to discern whether a defect, in particular ac rack, was generated as a result of the hydraulic pressure test.

Therefore, performing the tonal test before, during and after the hydraulic pressure test of a vessel makes it possible to use characteristic criteria to detect defects produced by the hydraulic pressure test by means of a relatively simple and noise-immune method. As a result, damages in subsequent operation that can be traced back to cracks, deformation and the like during the hydraulic can be prevented. IN addition, the test can be executed concurrently with the hydraulic pressure test, thereby shortening the idle time or downtime of the vessel.

### REFERENCE LIST

10 Pressure vessel
21 Supply line
14 Clapper
16 Buzzer
18 Airborne sound microphone
20 Structure-borne sound microphone
22 Evaluating unit

1. A method for detecting changes in pressure vessels while pressurizing the vessels during a hydraulic pressure test, involving the following steps: inducing a tone on the pressure vessel while pressurizing the pressure vessel during the hydraulic pressure test and evaluating the tonal spectrum induced on the pressure vessel.

2. The method according to claim 1, characterized in that tones are induced at least at two different times during the hydraulic pressure test, preferably at different internal pressures of the vessel, and that the tonal spectrum is evaluated relative to differences between the tonal spectra induced at different times.

3. The method according to claim 1, characterized in that pressurization involves one phase of rising pressure and one phase of falling pressure, and that tonal excitation takes place during the rising and/or falling pressure.

4. The method according to claim 1, characterized in that the tones are induced by means of a clapper, a mounted buzzer and/or a magnetostriction effect.

5. The method according to claim 1, characterized in that tonal excitation takes place at various positions of the pressure vessel.

6. The method according to claim 1, characterized in that the induced tone is recorded for evaluation as airborne sound and structure-borne sound.

7. The method according to claim 1, characterized in that the sound is recorded at several points for evaluation.

8. The method according to claim 1, characterized in that the sound echo times and/or echo time differences of the sound and/or sound transmission influences are taken into account while evaluating the tonal spectrum induced and acquired at various points of the pressure vessel.

9. The method according to claim 1, characterized in that the tonal spectrum is evaluated relative to a shift in the overall spectrum, the position of individual frequencies, the height of the amplitudes, the shapes of the frequency peaks and/or the steepness of the flank rise and/or fall.

10. A device for detecting changes or damages to pressure vessels while undergoing a hydraulic pressure test, encompassing:
a device for generating a tonal excitation on the pressure vessel while pressurizing the pressure vessel during the hydraulic pressure test;
a device for detecting the induced tonal spectrum; and
an evaluator for the tonal spectrum induced on the pressure vessel.

11. The device according to claim 10, characterized in that the device for generating a tonal excitation comprises means for inducing tones at several locations of the pressure vessel.

12. The device according to claim 10, 11, characterized in that the device for detecting the induced tonal spectrum comprises means for determining the tonal spectrum at several locations as structure-borne sound and/or airborne sound.
